(19) United States
(12) Patent Application Publication
(10) Pub. No.: US 2009/0181206 A1
(43) Pub. Date: Jul. 16, 2009

(54) Material for horse protect gear

(76) Inventor: Ju Sung Chang, Nantou County (TW)

Correspondence Address: BACON & THOMAS, PLLC, 625 SLATERS LANE, FOURTH FLOOR, ALEXANDRIA, VA, 22314-1176, US

(21) Appl. No.: 12/007,731

(22) Filed: Jan. 15, 2008

(51) Int. Cl. B32B 3/26; B32B 25/04

(52) U.S. Cl. 428/71; 428/137

(57) ABSTRACT

The invention is related to a material for horse protect gear which is mainly purposed to protect the material and products used for manufacturing protect gears, whereof a rubber or plastic foam body is used as the base material whose surface is bonded with a cloth; and the foam body and cloth combination is further made with a lot of through holes which pierce through the cloth and foam body, so that multiple small holes are visible on the cloth surface of the material to achieve a ventilation effect, thereby to enhance the conforming effect to the horse wearing the said protect gear without feeling sultriness.

### BACKGROUND OF THE INVENTION

(a) Field of the Invention

The invention is mainly related to the material for horse protect gear, whereof it can be widely applied on products such as girths, saddle pads, halters and leg protects, etc. to provide more ventilating comforts for the horses.

(b) Description of the Prior Art

In reining and riding horses, for safety concerns of the rider and horse, necessary safety protect gears such as girths, saddle pads, halters, leg protects, etc. are generally mounted on the horse. For these products, besides of their injury protection function, their wearing comfort and convenience shall also conform to user requirements. Hereof, the invention particular discloses a material and product for horse protect gear which is more effective to the use of the said protect gears.

### SUMMARY OF THE INVENTION

The purpose of the invention is to disclose a material for horse protect gear, it can be applied in the aforesaid products such as girths, saddle pads, halters, leg protects, etc. whereof a rubber or plastic foam body is used as the base material whose surface is bonded with a cloth; and the foam body and cloth combination is further made with a lot of through holes which pierce through the cloth and foam body, so that multiple small holes are visible on the cloth surface of the material. By utilizing its own rich elasticity characteristics, the foam body material is advantageous in distraction, anti-slip and anti-deformation capabilities; and is further made with multiple through holes to achieve wearing ventilation effect, thereby to promote comforts to the horse wearing the said protect gear without feeling sultriness.

Another purpose of the invention is that the exterior surface of the material is further sewn with a hard protect shell which is installed with multiple holes, whereof it is combined with the material to form the troughs for containing stuffing; the trough is closed by a cover which has an inside container, and the trough is installed with a ventilation hole for outside interaction; when stuffing such as aromatics, magnet stones or minerals are contained in the troughs, the dispersed energy of the said stuffing is released from the hole thereby to further diffuse an aromatic smell or to produce a physical effect.

### BRIEF DESCRIPTION OF THE DRAWINGS

FIG. 1 is a material structure diagram showing that surface of foam body is bonded with a cloth, whereof the cloth and foam body are provided with multiple through holes to constitute a horse protect gear.

FIG. 2 is a cross-sectional view of the material in FIG. 1 cut at the position of the section line.

FIG. 3 is another material embodiment.

FIG. 4 is a cross-sectional view of the material in FIG. 3 cut at the position of the section line.

FIG. 5 is another material embodiment.

FIG. 6 is a cross-sectional view of the material in FIG. 5 cut at the position of the section line.

FIG. 7 shows a nylon band with buckles is wrapped around by the said material while presented in a status with one side sewn and the other side un-sewn.

FIG. 8 shows the outlook of a completed girth.

FIG. 9 is the structure decomposition view of a leg protect constituted by the material of the invention.

FIG. 10 is the completion outlook drawing of the leg protect in FIG. 9.

FIG. 11 is a cross-sectional view of the material in FIG. 10 cut at the position of the section line

FIG. 12 is another embodiment drawing of leg protect.

### DESCRIPTION OF MAIN COMPONENT SYMBOLS

Please refer to the attached drawings, the preferred embodiment of the invention is specifically described in the following:

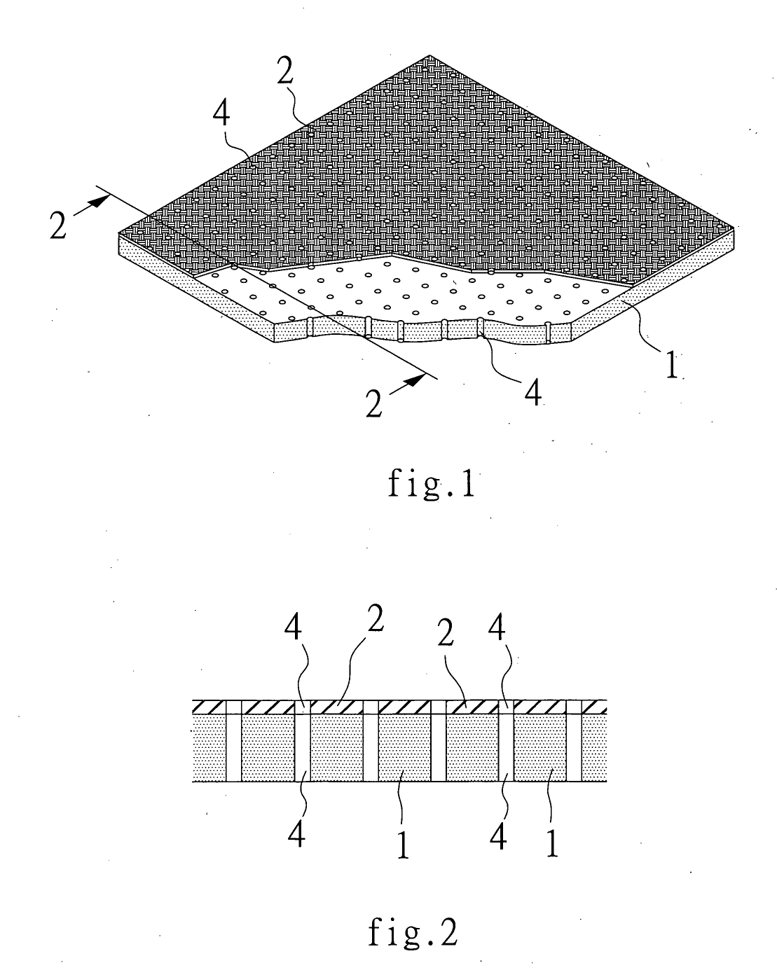

FIG. 1 is a material structure diagram showing that surface of foam body is bonded with a cloth, whereof the cloth and foam body are provided with multiple through holes to constitute a horse protect gear. FIG. 2 is a cross-sectional view of the material in FIG. 1 cut at the position of the section line. It can be further understood from the drawing that the material 12 is mainly constituted by a foam body 1 as the base material, whereof rubber or plastic material are optionally used as needed to make foam body 1 through foaming technology based on product structure requirements. The rubber type foam body 1 shall include the natural rubber type foam body 1 and the synthetic rubber type foam body 1, whereof the foam body 1 is bonded with a cloth 2 by binding material (glue, binder, etc.). Material characteristics of cloth 2 shall be selected to match with the elasticity of foam body 1. Generally, cloth 2 for an elastic foam body 1 shall be flexible to allow the integrally combined material of the two to become flexible. The combination of the body 1 and cloth 2 is further punched with multiple through holes 4 which pierce through cloth 2 and foam body 1 through a hole-punch die, so that multiple small holes are visible on the surface cloth 2, thereby to constitute the material 12 of the invention.

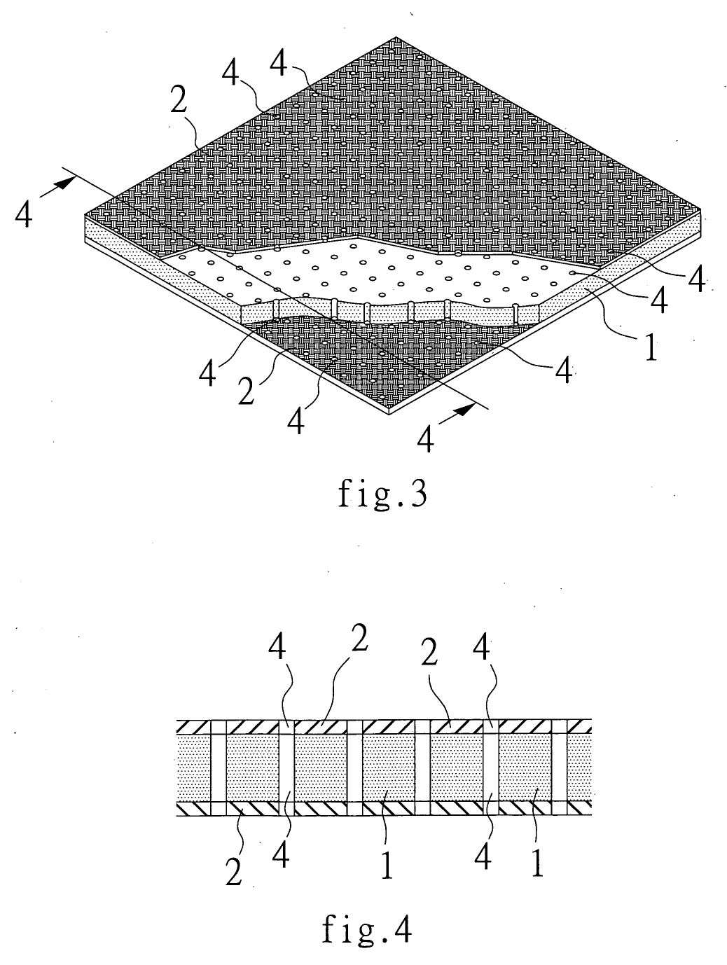

FIG. 3 is another material embodiment. FIG. 4 is a cross-sectional view of the material in FIG. 3 cut at the position of the section line. The material shown in FIG. is mainly comprised of that the top and bottom surface of the foam body 1 are respectively bonded with a cloth 2, and the foam body 1 and cloth 2 combination is made with multiple through holes 4 which can pierce through the cloth and foam body 1, so that multiple small holes are visible on the cloth 2 surface of the material 12, thereby to constitute another material embodiment of the invention.

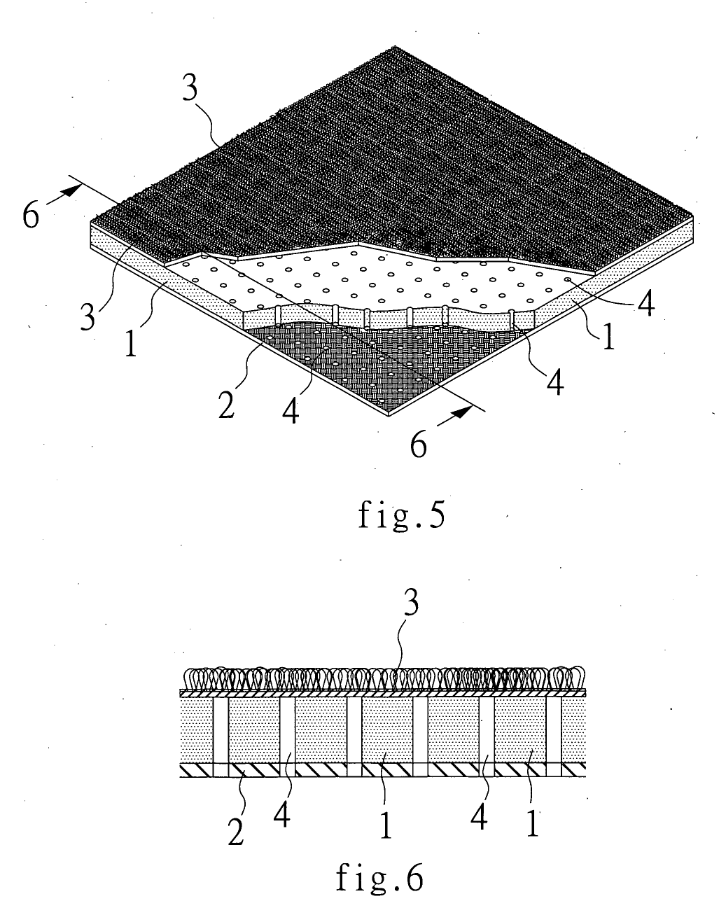

FIG. 5 is another material embodiment. FIG. 6 is a cross-sectional view of the material in FIG. 5 cut at the position of the section line. The material shown in the FIG. is mainly comprised of that one surface of the foam body 1 is bonded with a cloth 2, and the foam body 1 and cloth 2 combination is made with multiple through holes 4 which pierce through cloth 2 and foam body 1, so that multiple small holes are visible on the cloth 2 surface of material 12. Based on product manufacture requirements, another surface of the material is further combined with a velcro 3 which is usually made of nylon material. The said velcro 3 is constituted by numerous small ring holes to match with anther velcro 3 of numerous hooks, thereby to constitute another material embodiment of the invention.

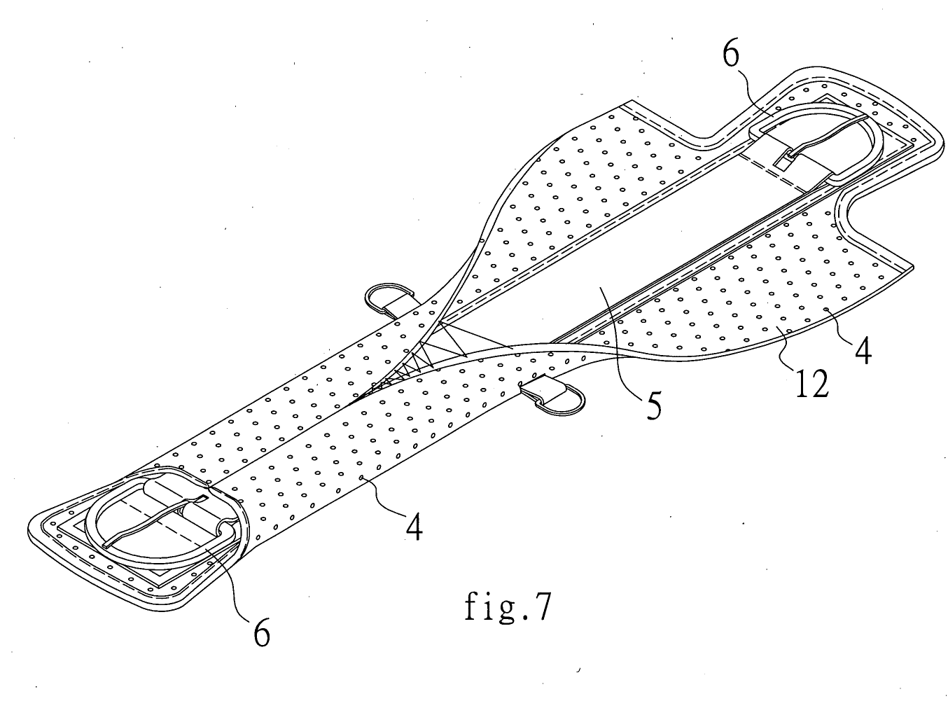

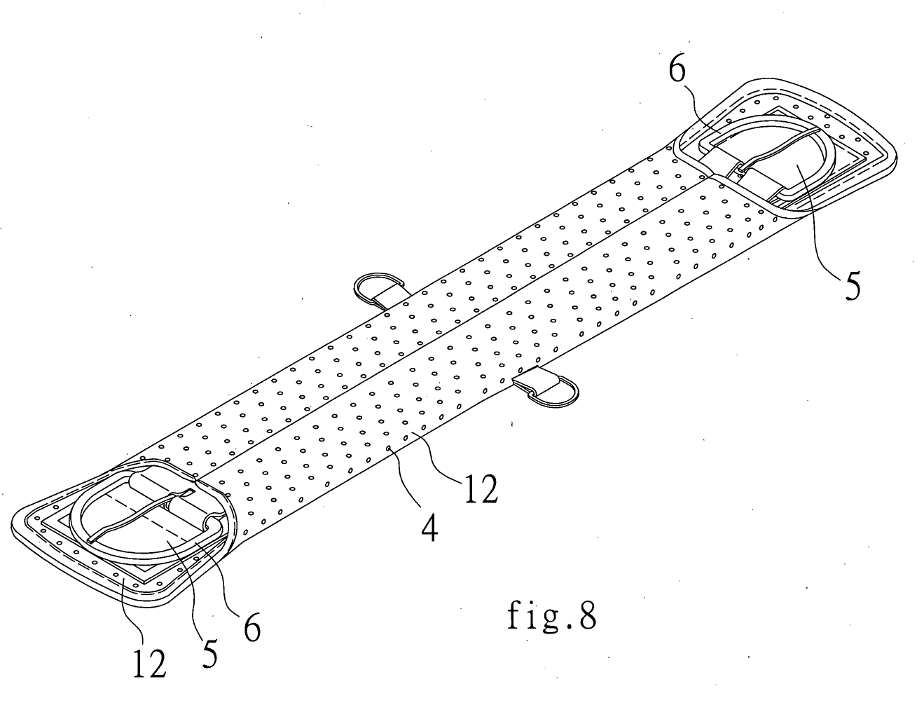

The aforesaid material 12 is made to various products of girths, saddle pads, halters and leg protects, etc., whereof the product examples of its embodiments are described in the following: The material used for the band surface of a horse girth is shown in FIG. 7, in which a nylon band 5 with buckles 6 is wrapped around by the material 12, whereof it is presented in a status with one side sewn and the other side remained un-sewn. The view of a completed girth is shown in FIG. 8.

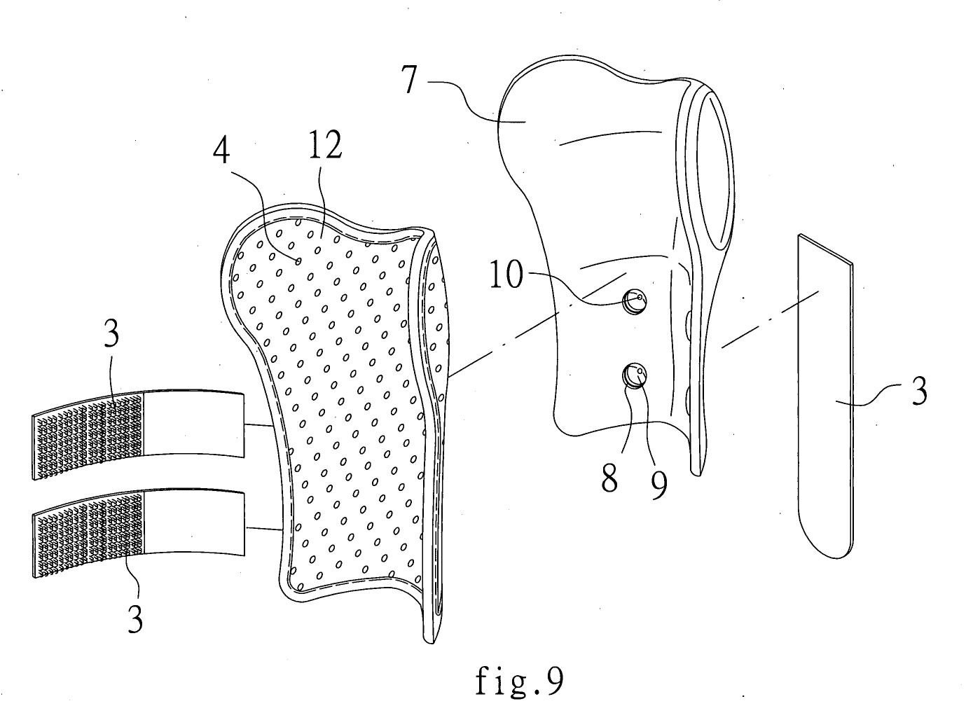

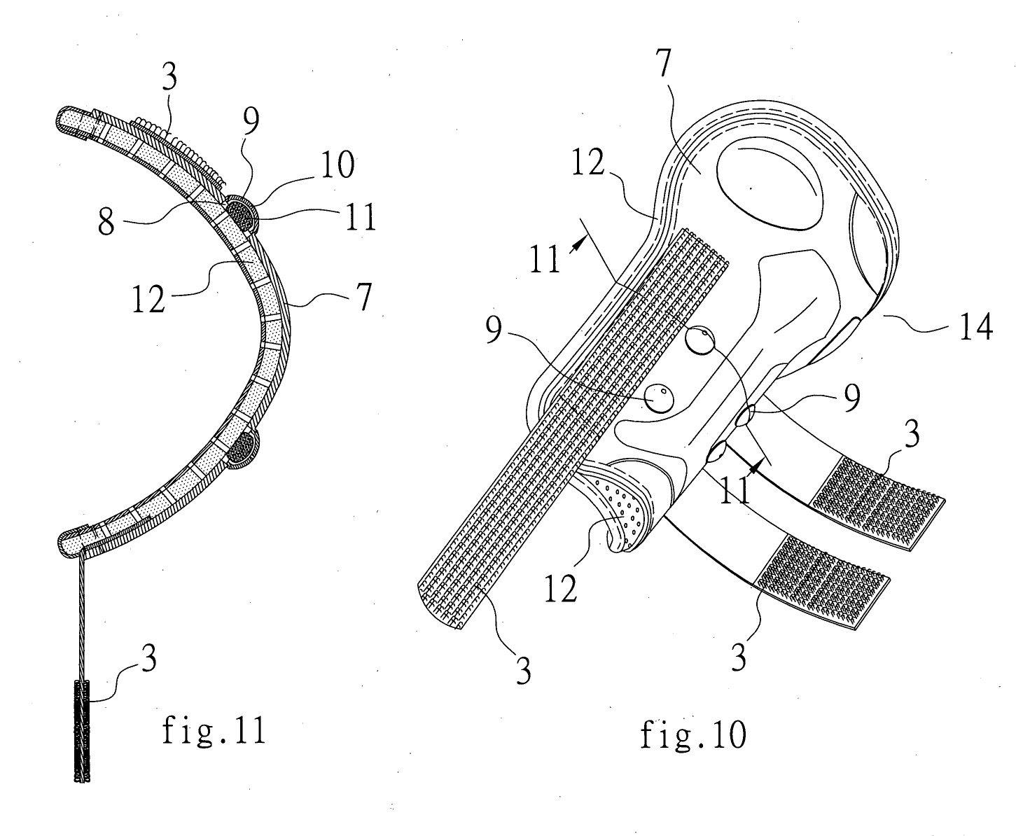

Another embodiment for leg protect 14 is shown in FIGS. 9, 10, 11. The exterior surface of the material 12 of the invention is further sewn with a hard protect shell 7 and velcros 3, whereby the leg protect is fastened to the horse leg 13 by velcros 3; the protect shell 7 is installed with multiple holes 8 which is combined with material 12 to form the troughs for containing stuffing 11; the trough is closed by a cover 9 which has an inside container, and the trough is installed with a ventilation hole 10 for outside interaction; when stuffing 11 such as aromatics, magnet stones or minerals are contained in the troughs, the dispersed energy of the said stuffing 11 is released from the hole, thereby to further diffuse an aromatic smell or to produce a physical effect.

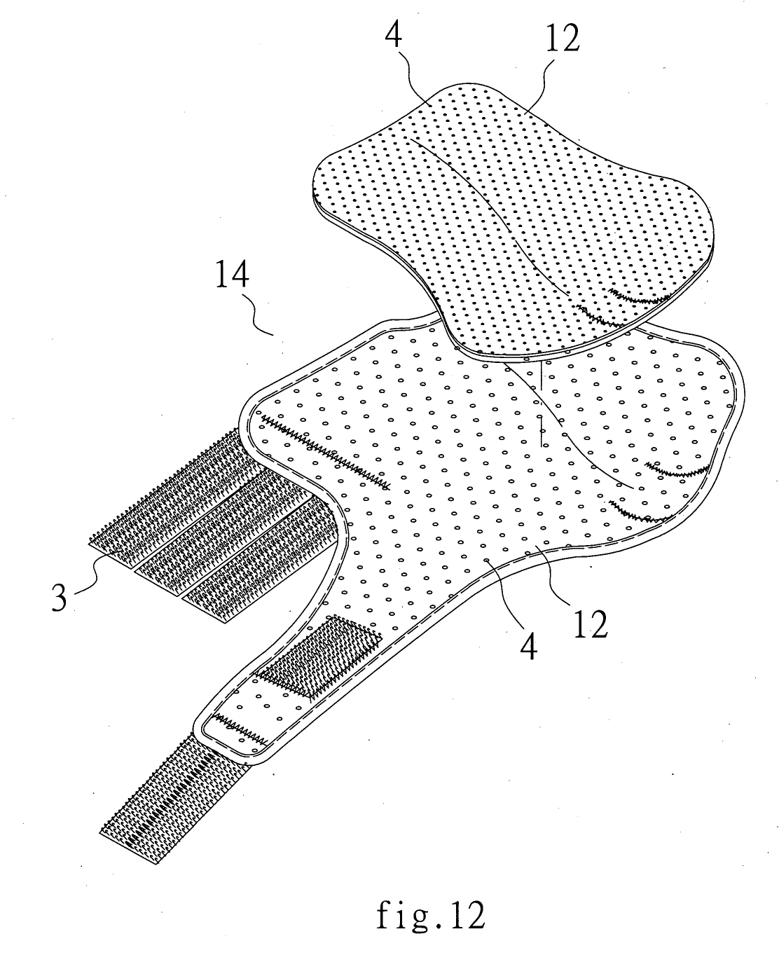

Another leg protect 14 embodiment is shown in FIG. 12, in which the material 12 is constituted by combining the materials 12 shown in FIG. 1 and FIG. 5; hereof, one side of the smaller area material 12 with through holes 4 is not bonded with cloth 2 but instead sewn to the interior side of a material 12 shown in FIG. 5 while whose other side with velcros 3 is facing outwards and whose peripheral boundary is sewn with velcros 3 of numerous hooks, thereby to constitute the leg protect 14.

1. A material for horse protect gear of the invention which is characterized in that a foam body is used as the base material, where of surface of the foam body is bonded with a cloth, and the cloth and foam body combination is provided with multiple through holes which pierce through the cloth and foam body, so that multiple small holes are visible on the cloth surface of the material.

2. The material for horse protect gear as in claim 1, in which the foam body of the said material is a rubber type foam body, whereof the said rubber type foam body includes the natural rubber foam body and synthetic rubber foam body.

3. The material for horse protect gear as in claim 1, in which the foam body is a plastic type foam body.

4. The material -for horse-protect gear as in claim 1, in which the said material is a flexible and elastic material.

5. The material for horse-protect gear as in claim 1, in which the said cloth is a vlecro.

6. The material for horse protect gear as in claim 1, whereof its said cloth surface is sewn to a hard protect shell installed with multiple holes; the said protect shell after combining the said material is further provided with troughs for containing stuffing; the trough is closed by a cover which has an inside container, and the trough is further installed with a ventilation hole for outside interaction; when stuffing such as aromatics, magnet stones or minerals are contained in the troughs, the dispersed energy of the said stuffing is released from the hole, thereby to further diffuse an aromatic smell or to produce a physical effect.
